(19) United States
(12) Patent Application Publication
(10) Pub. No.: US 2023/0021400 A1
(43) Pub. Date: Jan. 26, 2023

(54) SPHERICAL BEARING HAVING A SWAGED OUTER RING

(71) Applicant: SKF Aerospace France S.A.S, Montigny-le-Bretonneux (FR)

(72) Inventors: Florent RIVIERE, LONS LE SAUNIER (FR); Justin ESTEVE, CRANCOT (FR)

(21) Appl. No.: 17/860,558

(22) Filed: Jul. 8, 2022

(30) Foreign Application Priority Data
Jul. 21, 2021 (FR) 2107834

(51) Int. Cl. F16C 23/04

(52) U.S. Cl. CPC F16C 23/045

(57) ABSTRACT

A spherical bearing having an outer ring and an inner ring respectively including an inner surface and an outer surface that are in contact with one another. Moreover, the material of the outer ring provides an alloy having the formula NiCr19Fe18Nb or an alloy having the formula X6NiCrTiMoVB25-15-2.

### CROSS-REFERENCE TO RELATED APPLICATIONS

This application claims priority to French Patent Application no. 2107834, filed Jul. 21, 2021, the contents of which is fully incorporated herein by reference.

### TECHNICAL FIELD

The present invention relates in general to spherical bearings and, more particularly, to spherical bearings manufactured by swaging of an outer ring onto an inner ring. More specifically, the invention relates to a spherical bearing manufactured by swaging of an outer ring onto an inner ring, and having mechanical strength and corrosion resistance that are suitable for operation under high-temperature conditions, and to a method for manufacturing a spherical bearing of this kind.

### PRIOR ART

Typically, a spherical bearing comprises an outer ring and an inner ring. The outer and inner rings respectively comprise an inner surface and an outer surface that are in contact, forming sliding surfaces for the outer and inner rings to move relative to one another.

Depending on their location, some spherical bearings operate under high-temperature conditions, above 300° C. In order to ensure the integrity of the spherical bearings, it is imperative that they retain their mechanical strength under such conditions.

According to one particular existing method, the manufacture of a spherical bearing is based on a swaging process.

In a first instance, the outer ring and inner ring are assembled, and then the outer ring is swaged directly onto the inner ring, which serves as a die. The shape of the outer surface of the inner ring is imparted to the inner surface of the outer ring. The resulting swaged spherical bearing is referred to in English simply as a “swaged bearing”.

Bronze or stainless steels, for example CRES (or “corrosion-resistant steel”) are the materials conventionally used to form the outer ring of a swaged spherical bearing.

However, these conventional materials lose their mechanical strength under high-temperature conditions, in particular at temperatures above 300° C. Furthermore, in the case of CRES, the corrosion resistance properties are also reduced.

Consequently, swaged spherical bearings cannot be used in applications that involve high temperatures.

Other types of spherical bearing can be used at high temperatures. For example, a split spherical bearing is manufactured by assembling an inner ring that is cut into two parts inside an outer ring. A spherical bearing of this kind is referred to in English simply as a “split bearing”.

Nonetheless, the process for manufacturing split spherical bearings is costly.

### SUMMARY OF THE INVENTION

The invention therefore aims to remedy these drawbacks and to propose a low-cost manufacturing method with which it is possible to obtain a spherical bearing whose properties of mechanical strength and corrosion resistance are suited to applications under conditions of temperatures above 300° C.

The invention therefore proposes a spherical bearing comprising an outer ring and an inner ring respectively comprising an inner surface and an outer surface that are in contact with one another.

Moreover, the material of the outer ring comprises an alloy having the formula NiCr19Fe18Nb or an alloy having the formula X6NiCrTiMoVB25-15-2.

The alloys of formula NiCr19Fe18Nb and of formula X6NiCrTiMoVB25-15-2 are superalloys whose properties of mechanical strength and corrosion resistance are suitable for withstanding high-temperature conditions, in particular above 300° C.

Furthermore, these alloys are advantageously able to undergo a plastic deformation applied to the outer ring during a swaging step that is characteristic of the manufacture of a swaged bearing, without their mechanical properties being affected.

According to one exemplary embodiment, the inner surface of the outer ring can be concave spherical, and the outer surface of the inner ring can be convex spherical.

The invention also relates to a method for manufacturing a spherical bearing, comprising:

a step of positioning and outer ring on an inner ring, the outer and inner rings respectively comprising an inner surface and an outer surface that are in contact with one another; and

a step of swaging the outer ring onto the inner ring, the outer surface of the inner ring being used as the die which imparts its shape to the inner surface of the outer ring.

Moreover, the material of the outer ring comprises an alloy having the formula NiCr19Fe18Nb or an alloy having the formula X6NiCrTiMoVB25-15-2.

According to one exemplary embodiment, the outer surface of the inner ring can be convex spherical so as to form a concave spherical inner surface for the outer ring during this swaging step.

Advantageously, the manufacturing method may comprise, after the swaging step, a step of machining an outer surface and/or lateral faces of the swaged outer ring.

Preferably, the manufacturing method may comprise, after the swaging step, a step of lubricating the inner surface of the outer ring and the outer surface of the inner ring.

Preferably, the lubrication step is carried out after the swaging step.

Advantageously, the lubricant may comprise molybdenum disulphide or graphite.

According to one feature, the manufacturing method may further comprise, prior to the positioning step, a step of manufacturing the outer ring and inner ring.

### BRIEF DESCRIPTION OF THE DRAWINGS

At least one of the embodiments of the present invention is accurately represented by this application's drawings which are relied on to illustrate such embodiment(s) to scale and the drawings are relied on to illustrate the relative size, proportions, and positioning of the individual components of the present invention accurately relative to each other and relative to the overall embodiment(s). Those of ordinary skill in the art will appreciate from this disclosure that the present invention is not limited to the scaled drawings and that the illustrated proportions, scale, and relative positioning can be varied without departing from the scope of the present invention as set forth in the broadest descriptions set forth in any portion of the originally filed specification and/or drawings. Other aims, advantages and features will emerge from the following description, which is provided purely for illustrative purposes and with reference to the appended drawings, in which:

FIG. 1 is a section view of a spherical bearing comprising an outer ring and an inner ring, according to one exemplary embodiment of the invention;

FIG. 2 depicts a method for manufacturing the spherical bearing of FIG. 1, according to one exemplary embodiment of the invention;

FIG. 3 is a section view of the outer ring of the spherical bearing of FIG. 1, prior to being positioned on the inner ring;

FIG. 4 is a section view of the inner ring of the spherical bearing of FIG. 1, prior to being positioned in the outer ring;

FIG. 5 is a section view of the spherical bearing of FIG. 1, after the outer ring has been swaged onto the inner ring.

### DETAILED DESCRIPTION OF THE INVENTION

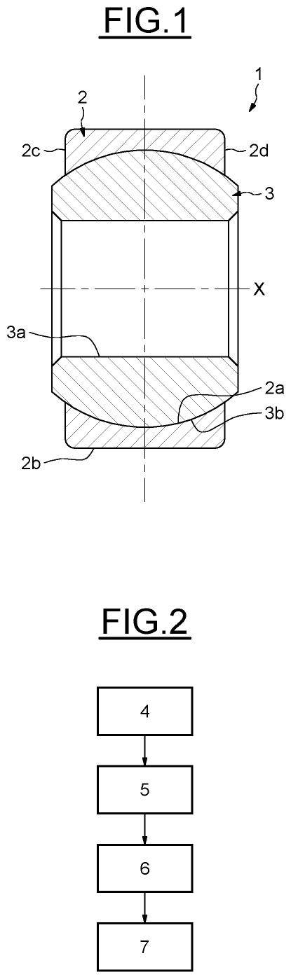

Those of ordinary skill in the art will appreciate from this disclosure that when a range is provided such as (for example) an angle/distance/number/weight/volume/spacing being between one (1 of the appropriate unit) and ten (10 of the appropriate units) that specific support is provided by the specification to identify any number within the range as being disclosed for use with a preferred embodiment. For example, the recitation of a percentage of copper between one percent (1%) and twenty percent (20%) provides specific support for a preferred embodiment having two point three percent (2.3%) copper even if not separately listed herein and thus provides support for claiming a preferred embodiment having two point three percent (2.3%) copper. By way of an additional example, a recitation in the claims and/or in portions of an element moving along an arcuate path by at least twenty (20°) degrees, provides specific literal support for any angle greater than twenty (20°) degrees, such as twenty-three (23°) degrees, thirty (30°) degrees, thirty-three-point five (33.5°) degrees, forty-five (45°) degrees, fifty-two (52°) degrees, or the like and thus provides support for claiming a preferred embodiment with the element moving along the arcuate path thirty-three-point five (33.5°) degrees. FIG. 1 shows a spherical bearing 1, of axis X, comprising an outer ring 2 and an inner ring 3 onto which the inner ring 3 is swaged. The outer and inner rings 2, 3 are coaxial, of axis X.

According to the depicted exemplary embodiment, the spherical bearing 1 is a radial spherical bearing.

In one variant embodiment, the spherical bearing may be of a different kind, in particular non-radial or non-spherical, such as an angular- or axial-contact bearing.

The outer ring 2 comprises an inner surface 2a that forms a bore, and an outer surface 2b that is radially opposite the inner surface 2a. The outer ring 2 also comprises two mutually opposite radial frontal faces 2c, 2d that axially delimit the inner surface 2a and the outer surface 2b.

The inner ring 3 comprises an inner surface 3a that forms a bore, and an outer surface 3b that is radially opposite the inner surface 3a. The inner ring 3 also comprises two mutually opposite radial frontal faces (no reference) that axially delimit the inner surface 3a and the outer surface 3b.

The inner surface 2a of the outer ring and the outer surface 3b of the inner ring are in direct contact with one another in order to allow the inner and outer rings 2, 3 to move relative to one another. In the exemplary embodiment shown, the inner surface 2a of the outer ring and the outer surface 3b of the inner ring are in contact with one another in the radial direction.

In the example shown, the inner surface 2a of the outer ring is concave spherical, and the outer surface 3b of the inner ring is convex spherical, so as to form a spherical bearing.

The material of the outer ring 2 comprises an alloy having the formula NiCr19Fe18Nb or an alloy having the formula X6NiCrTiMoVB25-15-2. Preferably, the outer ring 2 is made entirely of an alloy having the formula NiCr19Fe18Nb or an alloy having the formula X6NiCrTiMoVB25-15-2.

The nickel-based alloy having the formula NiCr19Fe18Nb is for example the material known by the name Inconel® 718.

The alloy having the formula X6NiCrTiMoVB25-15-2 is for example the material known by the name A286®.

The mechanical strength and corrosion resistance properties of the alloys of formula NiCr19Fe18Nb and of formula X6NiCrTiMoVB25-15-2 are suitable for withstanding high-temperature conditions above 300° C.

Furthermore, they are advantageously able to undergo a deformation applied during a swaging step, without their mechanical properties being affected.

A method for manufacturing the spherical bearing 1 is illustrated in FIG. 2.

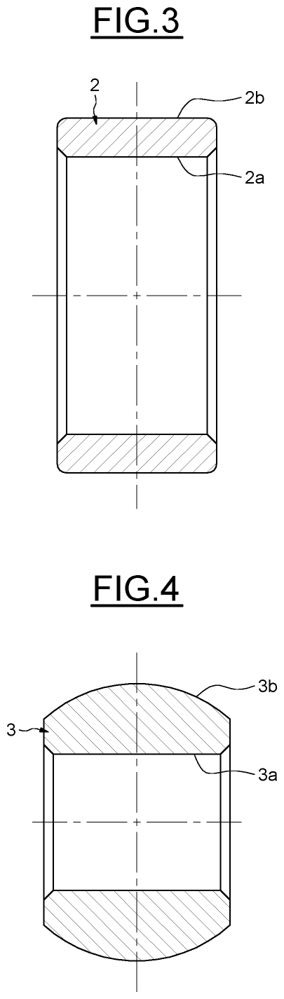

In a first, positioning step 4, the outer ring 2 comprising an alloy of formula NiCr19Fe18Nb or an alloy of formula X6NiCrTiMoVB25-15-2 is positioned on the inner ring 3. The outer and inner rings 2 and 3, respectively illustrated in FIGS. 3 and 4, are assembled in such a way that their respective inner and outer surfaces 2a, 3b are arranged facing one another.

In a second step 5, the outer ring 2 is directly swaged onto the inner ring 3, the latter being used as the die. The swaging step 5, which in this example is carried out cold, allows the shape of the outer surface 3b of the inner ring 3 to be imparted to the inner surface 2a of the outer ring 2 by plastic deformation.

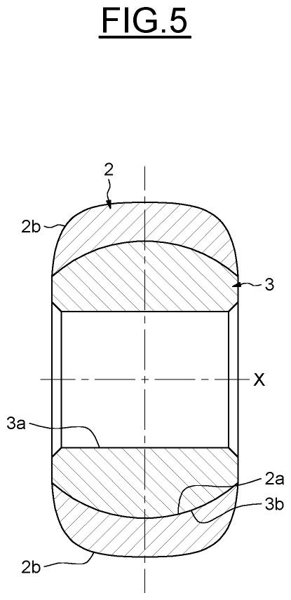

As shown in FIG. 5, the shape of the inner surface 2a of the outer ring 2, obtained by swaging, is concave spherical provided that the outer surface 3b of the inner ring is convex spherical.

The inner surface 2a of the outer ring 2 and the outer surface 3b of the inner ring 3 obtained in this manner are designed to cooperate and to allow the inner and outer rings 2, 3 to move relative to one another.

Advantageously, the manufacturing method comprises a subsequent step 6 of machining the outer surface 2b of the swaged outer ring 2.

As shown in FIG. 1, the outer surface 2b of the outer ring 2 has been machined so as to obtain a cylindrical surface.

The lateral faces 2c and 2d have also been machined so as to obtain planar faces.

Moreover, the manufacturing method may comprise a step 7 of lubricating the inner surface 2a of the outer ring 2 and the outer surface 3b of the inner ring 3.

The lubrication step 7 may be carried out prior to or after the swaging step 5.

The lubricant is for example a dry lubricant and may comprise molybdenum disulphide or graphite.

According to one exemplary embodiment, the manufacturing method may further comprise, prior to the positioning step 4, a step of manufacturing the outer ring and inner ring 2, 3.

1. A spherical bearing comprising:
an outer ring and an inner ring that respectively comprise an inner surface and an outer surface that are in contact with one another, wherein
the material of the outer ring comprises an alloy having the formula NiCr19Fe18Nb or an alloy having the formula X6NiCrTiMoVB25-15-2.

2. A spherical bearing according to claim 1, wherein the inner surface of the outer ring is concave spherical, and the outer surface of the inner ring is convex spherical.

3. A method for manufacturing a spherical bearing comprising:
a step of positioning and outer ring on an inner ring, the outer and inner rings respectively comprising an inner surface and an outer surface that are in contact with one another; and
a step of swaging the outer ring onto the inner ring, the outer surface of the inner ring being used as the die which imparts its shape to the inner surface of the outer ring, wherein
the material of the outer ring comprises an alloy having the formula NiCr19Fe18Nb or an alloy having the formula X6NiCrTiMoVB25-15-2.

4. The manufacturing method according to claim 3, wherein the outer surface of the inner ring is convex spherical so as to form a concave spherical inner surface for the outer ring during this swaging step.

5. The manufacturing method according to claim 3, comprising, after the swaging step, a step of machining an outer surface and/or lateral faces of the swaged outer ring.

6. The manufacturing method according to claim 3, comprising, after the swaging step, a step of lubricating the inner surface of the outer ring and the outer surface of the inner ring.

7. The method according to claim 6, wherein after the swaging step, a step of machining an outer surface and/or lateral faces of the swaged outer ring and the lubrication step is carried out after the swaging step.

8. The manufacturing method according to claim 6, the lubricant comprising molybdenum disulphide or graphite.

9. The method according to claim 3 comprising, prior to the positioning step, a step of manufacturing the outer ring and inner ring.
